(19) United States
(12) Patent Application Publication
(10) Pub. No.: US 2010/0317759 A1
(43) Pub. Date: Dec. 16, 2010

(54) ADHESIVE SHEET AND METHOD FOR MANUFACTURING SAME

(75) Inventors: Jung-Hyun Ryu, Yong-in City (KR); Jeongwan Choi, Seoul (KR); Jin-Woo Park, Seoul (KR); Shin-ae Yang, Seoul (KR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/744,115

(22) PCT Filed: Nov. 21, 2008
(86) PCT No.: PCT/US08/84354

§ 371 Date: May 21, 2010

(30) Foreign Application Priority Data
Nov. 26, 2007 (KR) 10-2007-0120938

(51) Int. Cl. C08L 33/08; B29C 44/20

(52) U.S. Cl. 521/149; 264/415

(57) ABSTRACT

Disclosed is a method for manufacturing an adhesive sheet, including the steps of: (i) forming polymer syrup using monomer for adhesive polymer resin; (ii) injecting gas into the polymer syrup to form bubbles; (iii) forming an adhesive mixture by adding a conductive filler to the polymer syrup having the bubbles and mixing the conductive filler with the polymer syrup; (iv) manufacturing the mixture in a form of a sheet; and (v) irradiating light onto at least two surfaces of the sheet to photopolymerize the adhesive mixture. Gas is injected into polymer syrup before the conductive filler is added to the polymer syrup to form bubbles, thereby obtaining an adhesive sheet capable of shielding and/or absorbing an electromagnetic radiation with dimensional stability and adhesive force superior to that of comparative adhesive sheets.

### BACKGROUND

The present invention relates to a method for manufacturing an adhesive sheet capable of shielding and/or absorbing electromagnetic radiation.

Most electronic products include a combination of various components. When assembling such electronic products, adhesive sheets having various thicknesses and various desired performance characteristics are used such that the components can easily realize their intended functions.

The adhesive sheet employed in an electronic product must bond different components to each other and exhibit certain additional functional properties such as thermal conductivity, electromagnetic wave shielding properties, and electromagnetic wave absorption properties such that the bonded components perform their intrinsic functions.

In order to perform the above functions, the adhesive sheet may include various kinds of fillers. Such fillers include, for example, thermally conductive fillers, electromagnetic wave shielding fillers, and electromagnetic absorption fillers. The adhesive force of the adhesive sheet can, however, be significantly degraded because of the presence of the filler.

### SUMMARY

To solve these problems, a novel adhesive sheet has been developed in which a foaming agent is added to an adhesive agent to form bubbles in the adhesive agent such that the softness and wettability of the adhesive agent are increased.

The present inventors have found that, when an adhesive sheet having a porous structure is manufactured through a conventional process in which the mechanical frothing process is performed to form the porous structure after mixing adhesive polymer resin with a conductive filler, a machine is abraded due to a conductive filler so that the life span of the machine is shortened.

In addition, the present inventors have found that, when a great amount of conductive fillers are added to adhesive polymer resin, or a conductive filler is mixed with adhesive polymer resin for a long time, bubbles in the adhesive sheet coalesce with one another, thereby increasing electrical resistance, and easily causing deformation of the adhesive sheet in compression.

Therefore, the present inventors provide a method of manufacturing an adhesive sheet having a porous structure, in which gas is injected into polymer syrup that has no filler, and then a predetermined amount of filler is mixed with adhesive polymer resin for a predetermined time, thereby manufacturing the adhesive sheet having the porous structure.

According to one aspect of the present invention, there is provided a method for manufacturing an adhesive sheet, including the steps of (i) forming polymer syrup using monomer for forming adhesive polymer resin; (ii) injecting gas into the polymer syrup to form bubbles; (iii) mixing a conductive filler with the polymer syrup having the bubble to form an adhesive mixture; (iv) making the adhesive mixture in a form of a sheet; and (v) irradiating light onto at least one surface of the sheet to photopolymerize the adhesive mixture.

According to the present invention, there is provided to an adhesive sheet made according to the above manufacturing method.

### BRIEF DESCRIPTION OF THE DRAWINGS

FIG. 1 is a view depicting a method for manufacturing an adhesive sheet according to an embodiment of the present invention;

FIG. 2 is a cross-sectional view of an adhesive sheet according to an embodiment of the present invention;

FIG. 3 is a graph showing compressive stain of adhesive sheets prepared in Example 1 and Comparative Example 2; and

FIG. 4 is a graph showing force and resistance versus distance for an adhesive sheet prepared in Example 1.

### DETAILED DESCRIPTION

Generally, if bubbles are formed by injecting gas into adhesive polymer syrup, an adhesive sheet may have a porous structure formed of bubbles. The softness of such adhesive sheet may be improved by the presence of the bubbles. If the softness of the adhesive sheet is improved, the spread of the adhesive sheet may be increased upon compression of the adhesive sheet (such as occurs during adhesive application), and the cohesion of the adhesive sheet may be improved even on an irregular surface, thereby improving the overall adhesive properties and characteristics of the adhesive sheet.

Adhesive sheets having such a porous structure can be manufactured using a method that includes the steps of mixing a conductive filler with adhesive polymer resin to form an adhesive mixture and injecting gas into the adhesive mixture to form bubbles. The gas can be mechanically distributed using a mixer. In this case, however, an impeller mounted on the mixer is abraded by the conductive filler contained in the adhesive mixture such that the life span of the mixer is reduced. Because of the abrasion, the user must purchase a high-priced mixer, increasing manufacturing costs.

According to one aspect of the methods of the present invention, bubbles are formed before a conductive filler is mixed with an adhesive polymer resin. Accordingly, the adhesive sheet of the present invention may have a porous structure formed of bubbles.

When conductive filler is added to and mixed with polymer resin after bubbles are formed in the polymer resin, abrasion of a mixer's mounted impeller can be prevented. In addition, if conductive filler is added to a polymer resin in which bubbles have already been formed and then stirred, the conductive filler can be uniformly distributed in the polymer resin, and it is possible both to prevent new bubbles from forming in the polymer resin and prevent existing bubbles from coalescing with each other during the stirring process. Because adhesive sheets manufactured according to the methods of the invention contain bubbles, the adhesive sheets exhibit improved cohesion and adhesion properties. The life span of high-priced mixing equipment can also be extended by use of these methods, thereby reducing manufacturing costs associated with the adhesive sheets.

To give surface and vertical conductivity to the adhesive sheet, continuous paths of conductive filler particles must be formed in the adhesive polymer resin. If, however, a great amount of conductive fillers is added to an adhesive polymer resin to form the continuous paths, particles of conductive fillers tend to coalesce with one another, thereby raising the viscosity of the adhesive resin. This can significantly degrade the physical properties of the adhesive polymer resin.

In addition, as mixing times for the polymer syrup and the conductive filler become lengthened, bubbles that may once have been uniformly distributed may coalesce, or an excess of bubbles may be created. Thereby, continuous paths between conductive filler particles cannot be easily formed, and electrical resistance is increased.

Further, as storage times for bubble-containing polymer syrups increase, distributed bubbles can be ejected from the surface of the polymer syrup, gradually decreasing the presence of bubbles in the adhesive sheet. This also tends to degrade the cohesion and the adhesion properties of the adhesive sheet.

To solve these problems, the present invention controls the amount of conductive filler included in an adhesive sheet and controls mixing times for the adhesive polymer resin and the conductive filler. Because adhesive sheets manufactured according to the invention exhibit both surface and vertical, the adhesive sheets of the invention can effectively shield and/or absorb electromagnetic radiation.

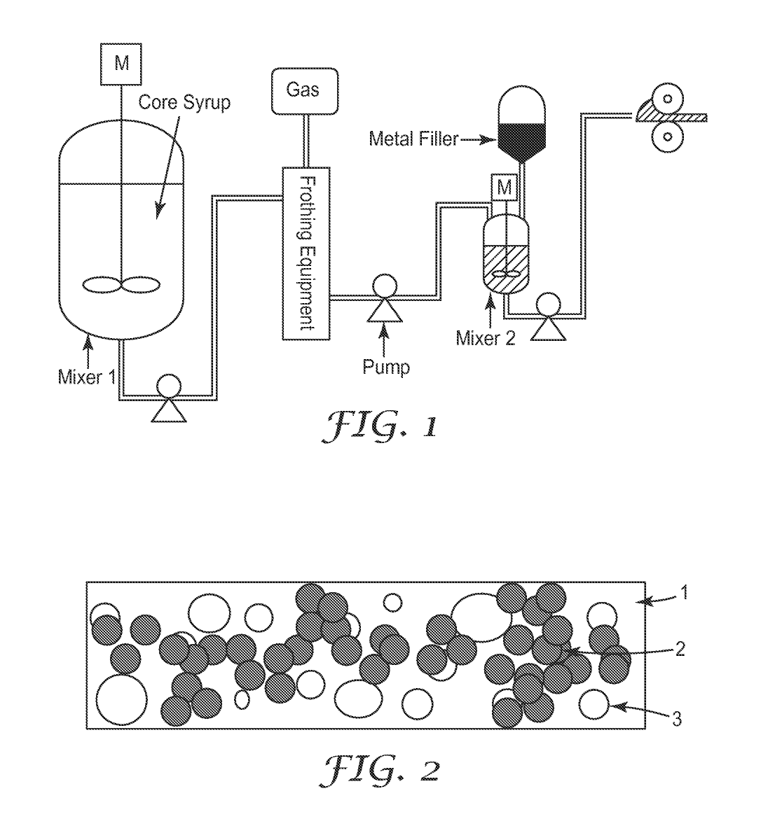

FIG. 1 depicts a manufacturing process according to one aspect of the present invention.

A method for manufacturing an adhesive sheet according to invention generally includes the steps of: (i) forming polymer syrup by using monomers for forming adhesive polymer resin; (ii) injecting gas into the polymer syrup to form bubbles; (iii) mixing conductive fillers with polymer syrup having bubbles to form an adhesive mixture; (iv) forming the adhesive mixture into sheet form; and (v) irradiating light on at least one surface of the adhesive sheet to photopolymerize the adhesive mixture.

In step (i), monomers for forming an adhesive polymer resin can be used to form the polymer syrup through typical polymerization. According to an embodiment of the invention, monomers for forming adhesive polymer resin are partially polymerized through radical polymerization using a photoinitiator, thereby forming uncured or semi-cured polymer syrup having a viscosity in the range of about 500 cPs to about 2000 cPs.

Useful monomers for forming an adhesive polymer resin include those monomers for forming acrylic polymer resins. The present invention is not, however, limited to any particular type of adhesive polymer resin. Preferred monomers for forming an acrylic polymer resin include photopolymerizable monomers such as alkyl acrylate ester monomers having an alkyl group having from 1 to 14 carbon atoms.

Non-limiting examples of such alkyl acrylate ester monomers include: buta (meta) acrylate, hexyl (meta) acrylate, n-octyl (meta) acrylate, isooctyl (meta) acrylate, 2-ethyl hexyl (meta) acrylate, isononyl (meta) acrylate, isooctyl acrylate, isonoyl acrylate, 2-ethyl-hexyl acrylate, decyl acrylate, dodecyl acrylate, n-butyl acrylate, hexyl acrylate and the like.

Although an alkyl acrylate ester monomer can be solely used to form polymer syrup, the alkyl acrylate ester monomers may be used together with one or more polar copolymerizable monomers to form a polymer syrup. Briefly, according to one embodiment of the invention, an alkyl acrylate ester monomer having a C₁ to C₁₄ alkyl group and a polar copolymerizable monomer can be used as the monomer for forming the adhesive polymer resin.

In this case, although the weight ratio of the alkyl acrylate ester monomer to the polar copolymerizable monomer is not limited to any particular range or value, it is preferably 99-50:1-50 in view of physical properties typically desired for the resulting adhesive polymer resin.

Non-limiting examples of suitable polar copolymerizable monomers include acrylic acid, itaconic acid, hydroxyalkyl acrylate, cyanoalkyl acrylate, acrylamide, substituted acrylamide, N-vinyl pyrrolidone, N-vinyl caprolactam, acrylonitrile, vinyl chloride, diallylphthalate and the like.

One or more surfactants may also be added to the polymer syrup. The surfactant is adsorbed on the interfacial surface of the polymer syrup to lower surface tension of the polymer syrup such that relatively small-sized bubbles can form through gas injection and the bubbles can maintain their shape. Useful surfactants typically are classified into anionic, cationic, zwitterionic, and nonionic surfactants according to the state of ionization and the subject of an active agent. Non-limiting examples of suitable surfactants include: poly vinyl pyrolidone (“PVP”), poly ethylene imine (“PEI”), poly methyl vinyl ether (“PMVE”), poly vinyl alcohol (“PVA”), polyoxyethylene alkyl phenyl ether, polyoxyethylene sorbitan monostearate, fluoroacrylate copolymer-ethyl acetate, etc. The amount of the surfactant will generally be in the range of about 0.1 to about 10 parts by weight based on 100 parts of adhesive polymer resin.

Step (ii) of the manufacturing method according an aspect of the present invention is a step of forming bubbles in the polymer syrup. Accordingly, the adhesive sheet manufactured according to the present invention may have a porous structure formed of bubbles. The methods for forming the porous structure in the polymer syrup include a mechanical frothing process using gas injection, polymer hollow microsphere distribution, or use of a thermal foaming agent, etc. According to one embodiment of the method, the porous structure can be formed in the polymer syrup by using a mechanical frothing process through gas injection. That is, if a mixer is used while injecting gas into the polymer syrup, the gas is uniformly distributed by an impeller mounted on the mixer, so that bubbles having generally uniform size are formed in the polymer syrup. Accordingly, the adhesive sheet can have a porous structure formed of bubbles.

Examples of the gas that can be used in the present invention include, but are not limited to, air, carbon dioxide, nitrogen, etc.

The flow rate of the gas will typically range from about 50 sccm to about 80 sccm. If the flow rate of the gas is excessively low, bubbles may be insufficiently formed in the polymer syrup. If the flow rate of the gas is excessively high, the gas may flow out in a state in which bubbles are not formed in the polymer syrup. According to one embodiment of the invention, if the flow rate of the gas is about 500 sccm, bubbles having an average diameter in the range of 10 μm to 100 μm are formed in polymer syrup.

Step (iii) of the manufacturing method according to the present invention is to form a mixture in a polymer syrup state by adding conductive fillers to the polymer syrup having bubbles formed in step (ii). The material of the conductive filler is not specifically limited, and any filler may be used in the invention without any particular limitation, as long as it serves to impart conductivity.

Examples of suitable conductive filler materials include: metals including noble metals and non-noble metals; noble metal-plated, noble and non-noble metals; non-noble metal-plated, noble and non-noble metals; noble or non-noble metal-plated non-metals; conductive non-metals; conductive polymers; and mixtures of any two or more of the above.

Specific examples of useful conductive filler materials include: noble metals, such as gold, silver and platinum; non-noble metals, such as nickel, copper, tin and aluminum; noble metal-plated noble and non-noble metals, such as silver-plated copper, nickel, aluminum, tin and gold; non-noble metal-plated noble and non-noble metals, such as nickel-plated copper and silver; noble metal or non-noble metal-plated non-metals, such as silver- or nickel-plated graphite, glass, ceramics, plastics, elastomers and mica; conductive non-metals, such as carbon black and carbon fibers; conductive polymers, such as polyacetylene, polyaniline, polypyrrole, polythiophene, polysulfurnitride, poly-p-phenylene, polyphenylenesulfide, poly-p-phenylenevinylene; and mixtures of any two or more of the above.

The conductive filler may have a particle-like shape. The shape of the conductive filler adaptable for the present invention is not specifically limited, and if the shape of the conductive filler can be classified a particle shape, any can be used. That is, if the filler material has a shape of the prior filler used to provide conductivity, any shape of filler can be used without any particular limitation. Specifically, the conductive filler may have the shape of a solid microsphere, a hollow microsphere, elastomeric particles, an elastomeric balloon, a fragment, a plate, a fiber, a rod, or an indeterminate form.

The conductive filler may have various sizes according to the type used. Although the size of the conductive filler is not limited, the conductive filler may have the average diameter in the range of about 0.20 μm to about 250 μm according to one embodiment of the invention. In addition, the conductive filler may have the average diameter in the range of about 1 μm to about 100 μm according to another embodiment of the invention.

An adhesive sheet of the invention may have conductivity by means of the above conductive filler, thereby shielding and/or absorbing electromagnetic radiation. In order to allow the adhesive sheet to more effectively shield and/or absorb an electromagnetic wave, the conductive filler is preferably uniformly distributed in the polymer syrup having bubbles, and a continuous path is preferably formed between particles of the conductive filler material. For example, preferably, the conductive filler is arranged in a thickness direction and/or a horizontal direction of the polymer syrup so that the conductive filler can be continuously connected from one surface of the adhesive sheet to the other surface of the adhesive sheet. Accordingly, the adhesive sheet according to the invention may have surface conductivity in the range of about 0.1 Ω/m² to about 50 Ω/m², or vertical conductivity in the range of about 0.01 Ω/m² to about 10 Ω/m² so that the adhesive sheet can effectively shield and/or absorb electromagnetic radiation.

The amount of conductive filler material can be adjusted such that the conductive filler forms a substantially continuous path. According to one embodiment of the invention, the amount of the conductive filler may be in the range of about 20 parts by weight to about 200 parts by weight based on 100 parts of adhesive polymer resin. If the amount of the conductive filler is less than about 20 parts by weight, the conductive filler does not form a substantially continuous path in the polymer syrup, and electromagnetic radiation is not effectively absorbed or shielded. In addition, if the amount of the conductive filler exceeds about 200 parts by weight, the viscosity of the adhesive sheet can be substantially increased and the physical properties of the adhesive sheet may be degraded.

In addition, in step (iii) of the method of the invention, bubbles tend to coalesce with one another, and the coalescing bubbles can disturb the conductive fillers that otherwise form a substantially continuous path in the polymer syrup. To prevent this, the mixing time of the conductive filler and the polymer syrup having bubbles is preferably kept less than or equal to about 20 minutes. Further, to ensure the conductive filler material is sufficiently dispersed in the polymer syrup having bubbles, the conductive filler is preferably stirred in the polymer syrup having bubbles for at least about 5 minutes. According to one embodiment of the invention, the mixing time of the conductive filler and the polymer syrup having bubbles is in the range of about 5 minutes to about 20 minutes.

Other fillers or filler materials may be employed in addition to the conductive filler material so long as the characteristics and usability of the adhesive sheet are not degraded. Such additional fillers include thermally conductive fillers, flame retardant fillers, antistatic agents and the like. These additional fillers typically can be used in an amount about 100 or less parts by weight, for example, about 10-100 parts by weight, based on 100 parts of adhesive polymer resin.

In step (iv) of the manufacturing method of the invention, the polymer syrup mixture formed in step (iii) becomes a sheet in the form of, for example, a tape. In this case, a light-transmitting release paper or liner can be used, and the mixture is disposed between the release papers or liners. By using the release papers or liners, a substantially oxygen-free environment can be provided. In addition, when the release paper or liner includes a light-shielding pattern, the release paper or liner can serve as a mask to control the penetration of light incident on the polymer syrup mixture.

Thereafter, light (preferably, ultra-violet radiation) is irradiated through the release paper or liner or another mask having a light-shielding pattern, so that the mixture is polymerized and cross-linked in a substantially oxygen-free environment. Preferably, light having the same intensity is irradiated onto each surface of the sheet, so that both surfaces of the sheet exhibit substantially the same adhesive force. Alternatively, light having different intensities can be irradiated onto each surface of the sheet, so that both surfaces of the sheet exhibit different resulting adhesive forces.

When light is irradiated onto both surfaces of the sheet, the concentration of oxygen is preferably kept to about 1000 ppm or less. As the concentration of the oxygen is kept low, the sheet generally will exhibit better adhesion properties because undesired oxidation reactions are avoided. After forming a sheet by disposing the mixture between the release liners, light may be irradiated onto the mixture through a light-shielding patterned mask in a chamber in which oxygen is substantially eliminated, for example, a chamber in which the density of oxygen is about 1000 ppm or less. If necessary, the concentration of the oxygen may be about 500 ppm or less.

A transparent plastic film comprising a release layer or low surface energy coating may be used as the light-transmitting release paper or liner. Useful light-transmitting release papers or liners include: polyethylene films, polypropylene films, and polyethyleneterephthalate (“PET”) films.

In addition to the light-transmitting release paper or liner, in order to irradiate light only on a selected portion of the sheet, a light-shielding patterned mask may also be used. Such a mask generally comprises one or more regions through which light can pass and one or more regions through which light cannot pass or light can pass in only a very small amount. Examples of such masks include: light-transmitting release papers or liners on which a predetermined light-shielding pattern is formed; nets meshes; and lattices.

The thickness of the release paper, liner or mask is not especially limited for use in the practice of the invention. According to one embodiment of the invention, the thickness of the release liner or mask may be in the range of about 5 μm to about 2 mm. If the release liner or mask is excessively thin, it may be difficult to form a pattern or dispose the mixture on the release liner or mask. Conversely, if the thickness of the release liner or mask is excessively thick, photopolymerization may not easily be performed. For this reason, it is generally preferred to use a release liner or mask having a thickness in the aforementioned range.

The intensity of light for carrying out the photopolymerization of the polymer syrup may any intensity of light conventionally applied for photopolymerization. According to one embodiment of the invention, the intensity of light that corresponds to that of ultraviolet light is preferably applied. If light having different intensities is irradiated onto opposing surfaces of the adhesive sheet, the adhesive sheet may have different adhesion force on each surface. In other words, relatively stronger light may be irradiated onto one surface of the adhesive sheet, and relatively weaker light may be irradiated onto the opposing surface of the sheet. The intensity of the weak light may, for example, correspond to about 10% to about 90% of the intensity of the strong light. According to one embodiment of the invention, light having intensity of 5.16 mW/cm² and light having intensity of 4.75 mW/cm² are irradiated onto the top surface and the bottom surface of the adhesive sheet, respectively, for approximately 520 seconds.

Although the thickness of the adhesive sheet according to the invention is not limited, the adhesive sheet preferably has a thickness capable of forming cross-linking during polymerization. As an example, the thickness of the adhesive sheet may be about 3 nm or less, although thicker dimensions are also considered useful. Preferably, the thickness of the adhesive sheet is in the range of about 25 μm to 3 mm. If the adhesive sheet is excessively thin, the adhesive force of the adhesive sheet may be compromised. Conversely, if the adhesive sheet is excessively thick, it may be difficult to apply the adhesive sheet to an electronic device having narrow intervals between electronic components.

In the manufacturing method according to the invention, a cross-linking agent may be used to perform cross-linking of adhesive polymer resin. The property of the adhesive polymer resin, particularly, the adhesion property of the adhesive polymer resin can be adjusted according to the amount of the cross-linking agent. The cross-linking agent may be used in an amount of about 0.05 to about 2 parts by weight based on 100 parts of the adhesive polymer resin. Available cross-linking agent include monomer-type cross-linking agents including multi-functional acrylates such as 1,6-hexanedioldiacrylate, trimethylolpropane, triacrylate, pentaerythritol triacrylate, 1,2-ethylene glycol diacrylate, 1,12-dodecanediolacrylate. The present invention is not, however, limited thereto.

In the manufacturing method according to the invention, a photoinitiator may be used, and the degree of polymerization of polymer resin can be adjusted according to the amount of photoinitiator employed. The photoinitiator may be used in an amount of about 0.01 to about 2 parts by weight based on 100 parts of the adhesive polymer resin. Non-limiting examples of suitable photoinitiators that can be used in the invention include, but are not limited to: 2,4,6-trimethylebenzoyl diphenyphosphineoxide, bis(2,4,6-trimethylbenzoyl) pheyl phosphineoxide, α,α-methoxy-α-hydroxyacetophenone, 2-benzoyl-2(dimethyl amino)-1-[4-(4-morphonyl)phenyl]-1-butanone, 2,2-dimethoxy 2-phenyl acetophenone, and the like.

FIG. 2 is a view showing the adhesive sheet manufactured according to the method of the present invention. As shown in FIG. 2, the adhesive sheet includes adhesive polymer resin 1 and adhesive filler 2 that is uniformly distributed in the adhesive polymer resin. The adhesive polymer resin has a porous structure formed of bubbles 3. The adhesive force of the adhesive sheet is about 300 gf/in to about 2500 gf/in, and the adhesive sheet may be used for various electronic applications.

### EXAMPLES

Hereinafter, the present invention will be further described with specific reference to examples, comparative examples and experimental examples. The examples, the experimental examples, and the comparative examples are used to illustrate the present invention, but the scope of the present invention is not limited thereto.

In the following description, “parts by weight” is based on 100 parts of the component of adhesive polymer resin formed through the polymerization of monomer.

### Example 1

First, 2-ethyl hexyl acrylate monomer and 0.04 parts by weight of Irgacure™-651 (α,α-methoxy-α-hydroxyacetphenone, a photoinitiator) were stirred, and then partially polymerized using an ultraviolet lamp, thereby obtaining 2-ethyl hexyl acrylate prepolymer.

Then, after putting 90 parts by weight of 2-ethyl hexyl acrylate prepolymer into a 1-liter glass reactor, 10 parts by weight of acrylic acid, 0.12 parts by weight of Irgacure™-819 (bis(2,4,6-trimethyl benzoyl)phenyl-phosphine oxide, a photoinitiator), 0.1 parts by weight of 1,6-hexanediol diacrylate (“HDDA”) (a cross-linking agent), and 0.13 parts by weight of fluoroacrylate copolymer-ethyl acetate (a surfactant), were mixed with the 2-ethyl hexyl acrylate prepolymer and then sufficiently stirred. Thereafter, the mixture was partially polymerized using an ultraviolet lamp, thereby obtaining a polymer syrup having a viscosity of about 1700 cPs.

Subsequently, nitrogen gas (99.99%) was injected into the polymer syrup at a flow rate of about 500 sccm using frothing equipment (an AP-mixer from Reica Co.) at a frequency of 60 Hz. The density of the polymer syrup was 0.83 g/mL.

Then, 30 parts by weight of nickel (a filament-type conductive filler) with an average particle diameter of about 1 μm, was mixed with the polymer syrup into which nitrogen gas was injected. They were then stirred for about 20 minutes, thereby creating a mixture in the form of a polymer syrup.

While the mixture in the polymer syrup state was being extruded from the glass reactor, a release liner for double-side curing made of a polypropylene film was disposed at both surfaces of the mixture in the polymer syrup state using a roll coating machine such that the thickness of the mixture became about 1 mm. The release paper was disposed at both surfaces of the mixture in the polymer syrup state, thereby preventing the mixture from making contact with air, particularly, oxygen.

Ultraviolet radiation of the same intensity was irradiated onto both surfaces of the mixture for 520 seconds using an ultraviolet lamp, thereby making an adhesive sheet.

### Comparative Example 1

2-ethyl hexyl acrylate monomer and 0.04 parts by weight of Irgacure™-651 (α,α-methoxy-α-hydroxyacetphenone, a photoinitiator) were stirred and then partially polymerized using an ultraviolet lamp to obtain a 2-ethyl hexyl acrylate prepolymer.

Then, after putting 90 parts by weight of the 2-ethyl hexyl acrylate prepolymer into a 1-liter glass reactor, 10 parts by weight of acrylic acid, 0.12 parts by weight of Irgacure™-819 (bis(2,4,6-trimethyl benzoyl)phenyl-phosphine oxide, a photoinitiator), 0.1 parts by weight of 1,6-hexanediol diacrylate (“HDDA”) (a cross-linking agent), and 0.13 parts by weight of fluoroacrylate copolymer-ethyl acetate (a surfactant), were mixed with the 2-ethyl hexyl acrylate prepolymer and then sufficiently stirred.

Then, 30 parts by weight of nickel (a filament-type conductive filler) with an average particle diameter of about 1 μm, was mixed with the mixture, and then stirred for a long time, thereby creating a mixture in the form of a polymer syrup.

Thereafter, nitrogen gas (99.99%) was injected into the polymer syrup at a flow rate of about 500 sccm using frothing equipment (an AP-mixer from Reica Co.) at a frequency of 60 Hz.

While the mixture in the polymer syrup state was being extruded from the glass reactor, the release liner for double-side curing made of a polypropylene film was disposed at both surfaces of the mixture in the polymer syrup state using a roll coating machine such that the thickness of the mixture became about 1 mm. The release liner was disposed at both surfaces of the mixture in the polymer syrup state, thereby preventing the mixture from making contact with air, particularly, oxygen.

Ultraviolet radiation of the same intensity was irradiated onto both surfaces of the mixture for 520 seconds by using an ultraviolet lamp, thereby making an adhesive sheet.

### Comparative Example 2

An adhesive tape was prepared in the same manner as in Comparative Example 1, except that nitrogen gas was not injected into the mixture.

### Compressive Strain Measurement

The compressive strain of the adhesive sheet manufactured in Example 1 and Comparative Example 2 was measured as follows.

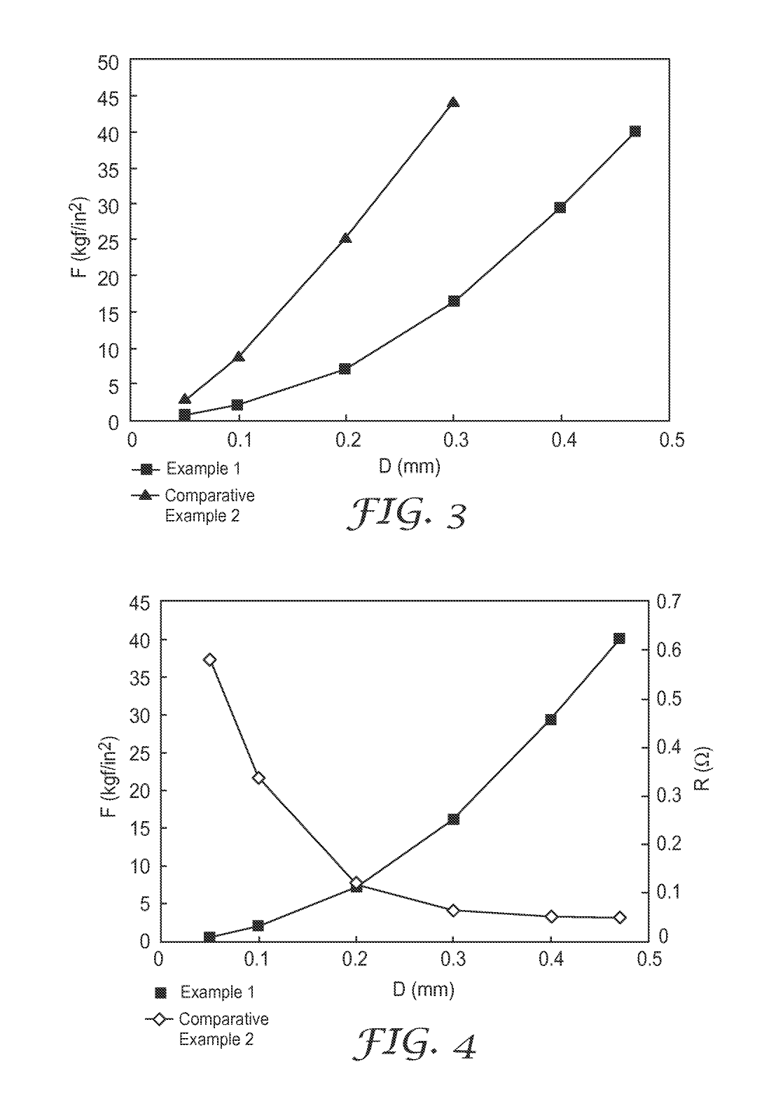

The adhesive sheet manufactured in Example 1 and Comparative Example 2 was prepared by cutting the adhesive sheets into a desired size. Thereafter, a metal terminal to measure DC resistance was placed between both heads of a universal test machine (“UTM”) and the test specimens were attached to the metal terminal. Then, the interval between both heads was narrowed by the thickness of the test specimens, and the heads were slowly compressed to measure the thickness variation of the test specimens according to a compressing force. The measurement results are shown in FIG. 3.

As shown in the results, the adhesive sheet in Comparative Example 2 was deformed by about 50% in compression with a force of 45 kgf/in². The adhesive sheet in Example 1 was deformed by about 30% in compression with a force of 45 kgf/in².

Accordingly, it can be recognized that the adhesive sheet manufactured according to the present invention has low compressive strain, that is, superior dimensional stability.

### Resistance Measurement

The volume resistance of the adhesive sheet manufactured in Example 1 was measured using a Mil-G-83528 surface probe scheme.

Test specimens were prepared by cutting the adhesive sheet manufactured in Example 1 into square specimens measuring 1 inch by 1 inch. The volume resistance of the test specimens was measured by using a Kiethely™ 580 micro-ohmmeter while the test specimens were being compressed by the universal test machine. The measurement results are shown in FIG. 4.

As shown in the results, the volume resistance of the adhesive sheet manufactured in Example 1 was about 0.32Ω when the adhesive sheet was compressed as about 0.1 mm. In addition, when the adhesive sheet was compressed as about 0.3 mm, the volume resistance of the adhesive sheet manufactured in Example 1 was about 0.06Ω.

### Measurement of Adhesive Force

The adhesive sheets manufactured in Example 1 and Comparative Example 1 were combined with aluminum according to the ASTM D 1000, and the adhesive force of the adhesive sheets for steel was measured in a direction of 180° using the UTM.

As a measurement result, the adhesive sheet manufactured in Comparative Example 1 represented adhesive force of about 1.5 kgf/in, and the adhesive sheet manufactured in Example 1 represented adhesive force of about 2.23 kgf/in.

Accordingly, it can be recognized that the adhesive sheet according to the present invention has adhesive force superior to that of the prior adhesive sheet.

According to the methods of the present invention, gas is injected into polymer syrup before conductive filler is added to the polymer syrup to form bubbles, thereby obtaining an adhesive sheet capable of shielding and/or absorbing electromagnetic radiation with dimensional stability and adhesive force superior to that of comparative adhesive sheets.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. A method for manufacturing an adhesive sheet, the method comprising the steps of:
(i) forming polymer syrup using monomer for forming adhesive polymer resin;
(ii) injecting gas into the polymer syrup to form bubbles;
(iii) mixing conductive filler with the polymer syrup having the bubbles to form an adhesive mixture; and
(iv) making the adhesive mixture in a form of a sheet; and
(v) irradiating light onto at least one surface of the sheet to photo-polymerize the adhesive mixture.

2. The according to claim 1, wherein the amount of conductive filler is in a range of about 20 to about 200 parts by weight based on 100 parts of the adhesive polymer resin.

3. The method according to claim 1, wherein the polymer syrup has viscosity in a range of about 500 cPs to about 20,000 cPs.

4. The method according to claim 1, wherein the monomer forming the adhesive polymer resin is monomer capable of forming an acrylic polymer resin.

5. The method according to claim 4, wherein the monomer capable of forming an acrylic polymer resin is selected from the group consisting of (a) alkyl acrylate ester monomers having an C₁ to C₁₄ alkyl group, and (b) a mixture of an alkyl acrylate ester monomer and at least one polar copolymerizable monomer.

6. The method according to claim 5, wherein the alkyl acrylate ester monomer is selected from the group consisting of: butyl (meta) acrylate, hexyl (meta) acrylate, n-octyl (meta) acrylate, isooctyl (meta) acrylate, 2-ethyl hexyl (meta) acrylate, isononyl (meta) acrylate, isooctyl acrylate, isonoyl acrylate, 2-ethyl-hexyl acrylate, decyl acrylate, dodecyl acrylate, n-butyl acrylate, hexyl acrylate, and mixtures thereof.

7. The method according to claim 5, wherein the polar copolymerizable monomer is selected from the group consisting of: acrylic acid, itaconic acid, hydroxyalkyl acrylate, cyanoalkyl acrylate, acrylamide, substituted acrylamide, N-vinyl pyrrolidone, N-vinyl caprolactam, acrylonitrile, vinyl chloride, dually phthalate, and mixtures thereof.

8. (canceled)

9. The method according to claim 1, wherein, in step (ii), the flow rate is in a range of about 50 sccm to about 800 sccm.

10. The method according to claim 1, wherein, in step (ii), bubbles having an average diameter in a range of 10 μm to 100 μm are generated through gas injection.

11. The method according to claim 1, wherein the conductive filler is selected from the group consisting of: noble and non-noble metals; noble metal-plated, noble and non-noble metals; non-noble metal-plated, noble and non-noble metals; noble metal- or non-noble metal-plated, non-metals; conductive non-metals; conductive polymers; and mixtures thereof.

12. The method according to claim 11, wherein the noble metals includes gold, silver, and white gold; the non-noble metals includes nickel, copper, tin, and aluminum; the noble metal-plated, noble and non-noble metals include copper, nickel, aluminum, tin, and gold coated with silver; the non-noble metal-plated, noble and non-noble metals include copper, and silver coated with nickel; the noble metal- or non-noble metal-plated, non-metals includes conductive graphite, glass, ceramic, plastic, elastomer, and mica coated with silver, or nickel; the conductive non-metals include carbon black and carbon fiber; and the conductive polymers include polyacetylene, polyaniline, polypyrrole, polythiophene, polysulfurnitride, poly-p-phenylene, polyphenylenesulfide, and poly-p-phenylenevinylene.

13. The method according to claim 1, wherein the conductive filler has an average diameter in a range of about 0.20 μm to about 250 μm.

14. The method according to claim 1, wherein step (iii) further comprises adding at least one surfactant to the polymer syrup.

15. The method according to claim 14, wherein the amount of surfactant is in a range of about 0.1 to about 10 parts by weight based on 100 parts of the adhesive polymer resin.

16. The method according to claim 1, wherein, in step (v), the concentration of oxygen in the light irradiation is 1000 ppm or less.

17. The method according to claim 1, wherein the adhesive sheet has a thickness in a range of 25 μm to about 3 mm.

18. (canceled)

19. An adhesive comprising an adhesive polymer resin and a conductive filler that is substantially uniformly distributed in the adhesive polymer resin, and the adhesive polymer resin has a porous structure formed of bubbles.

20. (canceled)

21. The adhesive sheet of claim 19, wherein the adhesive force is in a range of about 300 gf/in to about 2500 gf/in.

22. The adhesive sheet of claim 19, wherein the adhesive sheet has compressive strain less than 30% when a thickness is 1 mm and a compressive force is about 45 kgf/in².

23. The adhesive sheet of claim 19, wherein the adhesive sheet has a surface conductivity in a range of about 0.1 Ω/m² to about 50 Ω/m², and vertical conductivity is in a range of about 0.01 Ω/m² to about 10 Ω/m².
